(19) United States
(12) Patent Application Publication
(10) Pub. No.: US 2025/0158475 A1
(43) Pub. Date: May 15, 2025

(54) ELECTRIC MOTOR, IN PARTICULAR RADIATOR FAN MOTOR

(71) Applicant: Brose Fahrzeugteile SE & Co. Kommanditgesellschaft, Würzburg, Würzburg (DE)

(72) Inventors: Christian WAGENBRENNER, Würzburg (DE); Felix HESS, Würzburg (DE)

(21) Appl. No.: 19/021,616

(22) Filed: Jan. 15, 2025

Related U.S. Application Data
(63) Continuation of application No. PCT/EP2023/069499, filed on Jul. 13, 2023.

(30) Foreign Application Priority Data
Jul. 15, 2022 (DE) 10 2022 207 248.0

(51) Int. Cl. H02K 5/10; B60K 11/02; H02K 11/33; H02K 21/22

(52) U.S. Cl. CPC H02K 5/10; H02K 11/33; H02K 21/22; B60K 11/02

(57) ABSTRACT

An electric motor includes a motor carrier with an electronics compartment and an axially raised sealing wall or receiving groove. A stator with a stator main body has stator teeth directed radially outwards. A stator winding is disposed on the stator main body. A rotor circulates around the stator. A pot-like rotor housing with permanent magnets is disposed on an inner-wall side. An electronics compartment lid has a lid base and a lid wall which is oriented axially relative to a motor axis and which, with the sealing wall or receiving groove of the motor carrier, forms at least one adhesive gap for receiving a potting compound sealing the electronics compartment.

### CROSS-REFERENCE TO RELATED APPLICATION

This application is a continuation, under 35 U.S.C. § 120, of copending International Patent Application PCT/EP2023/069499, filed Jul. 13, 2023, which designated the United States; this application also claims the priority, under 35 U.S.C. § 119, of German Patent Application DE 10 2022 207 248.0, filed Jul. 15, 2022; the prior applications are herewith incorporated by reference in their entirety.

### FIELD AND BACKGROUND OF THE INVENTION

The invention relates to an electric motor, in particular a brushless external rotor motor, preferably a radiator fan motor of a motor vehicle.

An electric motor of that type usually includes a rotor that is rotatably mounted relative to a fixed stator. In a brushless electric motor, the stator is equipped with a stator or rotating field winding, which generates a rotating magnetic field by applying an alternating current to it. The rotor is usually fitted with permanent magnets, which generate a rotor magnetic field that interacts with the rotating field of the stator.

In a brushless electric motor, the alternating current intended to supply the stator winding is usually generated by a converter (inverter). In smaller electric motors, the converter and the associated control electronics are often housed in an electronics compartment that is integrated into the electric motor or its motor housing. The control electronics must be protected from moisture, which is why such electric motors, for example those used as radiator fan motors in motor vehicles, place comparatively high demands on the tightness of the electronics compartment. In addition, the stator winding should be reliably electrically insulated from the stator main body, which is often constructed as a laminated core formed of stacked laminations.

A brushless electric motor, which is known from European Patent EP 2 852 035 B1, corresponding to U.S. Pat. Nos. 10,734,859 B2 and 10,734,860 B2, and configured as an internal rotor (motor), in particular a radiator fan motor, includes a rotor mounted rotatably relative to a stator and a motor carrier which contains an electronics compartment which is sealed or can be sealed with an electronics compartment lid to accommodate converter electronics. That includes a circuit board fitted with passive and active components as well as power semiconductors connected in a bridge circuit. The electronics compartment lid has a circumferential sealing groove, while the motor carrier has a sealing edge or sealing rib in the region of the electronics compartment, which engages form-lockingly in the sealing groove of the electronics compartment lid. A filling gap remains between the carrier-side sealing edge or sealing rib and the lid-side sealing groove to accommodate a sealing compound. Spacer cams or nubs are provided at exposed points to ensure centering and uniform gap formation. It has been found that such a rib/groove contour is susceptible to crevice corrosion and/or corrosive infiltration.

### SUMMARY OF THE INVENTION

It is accordingly an object of the invention to provide an electric motor, in particular a radiator fan motor, which overcomes the hereinafore-mentioned disadvantages of the heretofore-known motors of this general type and which addresses the problem of specifying an electric motor configured as an external rotor motor of which the electronics or carrier-side electronics compartment is reliably sealed. In particular, crevice corrosion and/or corrosive infiltration of the preferably moisture-tight or liquid-tight joining area between a motor carrier and an electronics compartment lid should be reliably avoided.

With the foregoing and other objects in view there is provided, in accordance with the invention, a brushless electric motor provided and set up in particular for a radiator fan motor of a motor vehicle, having a plate-like or plate-shaped motor carrier (a motor carrier plate) with an electronics compartment for accommodating electronics (inverter electronics) and a stator and a rotor circulating around it with a pot-like rotor housing, on the annular or housing wall of which permanent magnets are disposed on the inside wall. The stator of the electric motor, which is configured as an external rotor motor, is disposed on the support side of the motor carrier opposite the electronics compartment. The stator has a stator main body, which is preferably configured as a laminated core formed of stacked stator plates or laminations. The stator or its stator main body has a preferably annular main body portion and stator teeth disposed on the outside of the ring and directed radially outwards, on which coils of a stator winding (rotating field winding) are disposed. The rotor is mounted so as to be rotatable about a motor or rotation axis, which is preferably a rigid rotation axis, for example a rigid pivot bolt, fixed in the motor carrier, for example cast into it.

The motor carrier has a sealing wall or a receiving and/or sealing groove that is axially raised relative to the motor axis on the carrier side associated with the electronics compartment. An electronics compartment lid that closes the electronics compartment has a lid base and a lid wall that is molded onto it and oriented axially with respect to the motor axis, which forms at least one adhesive gap or a sealing groove with the sealing wall of the motor carrier for receiving a potting compound (sealing compound) that seals the electronics compartment.

Advantageous variants, embodiments and developments are the subject of the dependent claims.

The sealing wall on the carrier side can have a step on the inside wall against which the lid wall of the electronics compartment lid rests, forming the sealing groove for the potting compound. The sealing wall on the carrier side is particularly preferably configured as a double wall with a receiving groove into which the lid wall of the electronics compartment lid dips or engages. In other words, the carrier-side receiving groove is formed from two parallel groove walls, in particular as sealing walls, and a groove base.

It is expedient to form-relative to the motor axis-a radial adhesive gap for the potting compound on both sides of the lid wall of the electronics compartment lid, which lid wall dips into the receiving groove of the carrier-side sealing wall. Suitably, an axial adhesive gap for the potting compound—relative to the motor axis—is formed between the groove base of the receiving groove formed in or by the carrier-side sealing wall and the lid wall of the electronics compartment lid that dips into it.

The radial and axial adhesive gap formation advantageously provides a sealing contour—which is conveniently U-shaped in cross-section—that creates a particularly large infiltration path or a particularly long path for moisture. This reliably prevents crevice corrosion after the sealing groove or the radial and axial adhesive gaps have been filled with the sealing compound.

In an advantageous embodiment, at least one support dome projects into the receiving groove of the carrier-side sealing wall, against which the electronics compartment lid is supported, forming an axial gap as an axial adhesive gap for the potting compound. Suitably, several such support domes are provided along the receiving groove of the carrier-side sealing wall. It is expedient that the or each support dome is formed on the groove wall of the carrier-side receiving groove facing away from the electronics compartment.

According to a further advantageous embodiment, the lid wall of the electronics compartment lid, which lid wall dips into the carrier-side receiving groove, has at least one flared punched lug. This lies against a groove wall of the receiving groove, preferably against one of the support domes, forming an axial gap as an axial adhesive gap for the potting compound. Suitably, several such punched lugs are provided along the receiving groove of the carrier-side sealing wall.

Suitably, at least one contact dome or a spacer cam protrudes into the receiving groove, against which the lid wall of the electronics compartment lid is supported, forming a or the radial adhesive gap for the potting compound. Preferably, several such contact domes are provided along the receiving groove of the carrier-side sealing wall. Conveniently, the or each contact dome is formed on the groove wall of the carrier-side receiving groove facing the electronics compartment.

In other words, when the electronics compartment lid is placed on the electronics compartment and the lid wall is dipped into the carrier-side receiving groove, the contact and support domes ensure reliable centering or positioning of the electronics compartment lid on the one hand and secure adhesive gap formation on both sides of the lid wall and between this and the groove base of the receiving groove on the other. In comparison to a gap on one side between the lid wall of the electronics compartment lid and a sealing groove on the carrier side, this creates the longest possible path for moisture, which in turn significantly reduces the risk of gap corrosion.

A particularly advantageous development provides that the sealing wall on the carrier side encloses a plug compartment that can be filled with the potting compound and has a wall-free end face into which a plug part is inserted or can be inserted. Suitably, the plug part is also provided with a receiving groove which, when the plug part is fitted, is aligned or corresponds with the receiving groove on the carrier side, so that when the plug part is inserted into the wall-free end face, a circumferentially closed receiving groove is provided for the lid wall of the electronics compartment lid, which is preferably also circumferentially closed.

The plug part also conveniently forms a partition wall between the electronics compartment on the carrier side and the plug compartment on the carrier side. This suitably has a further wall-free end face opposite the plug part, into which a further plug part can suitably be inserted or fitted. This in turn forms a circumferentially closed plug compartment that can also be filled with the potting compound when the electronics compartment lid is fitted as intended during the filling of the sealing groove or the receiving groove. The further plug part is suitably connected to a connection cable with supply and/or control lines, which can be connected to the vehicle electrical system, for example, to supply power, voltage and/or signals to the motor electronics.

Other features which are considered as characteristic for the invention are set forth in the appended claims.

Although the invention is illustrated and described herein as embodied in an electric motor, in particular a radiator fan motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an exploded, diagrammatic, perspective view of a brushless electric motor in external rotor configuration, in particular as a radiator fan drive for a motor vehicle, with a rotor and with a stator having a stator winding (rotating field winding) and with a motor carrier with an electronics compartment for motor electronics (converter electronics) which can be closed with an electronics compartment lid;

FIG. 2 is a cross-sectional view of an electric motor as shown in FIG. 1;

FIG. 3 is a top-plan view of a rotor housing of the electric motor;

FIG. 4 is a perspective view of the electric motor with a view into the carrier-side electronics compartment surrounded by a sealing or receiving groove when the electronics compartment lid is removed;

FIG. 5 is a perspective view of the electric motor with the motor electronics removed from the electronics compartment on the carrier side as shown in FIG. 4;

FIG. 6 is a bottom-plan view of the electric motor with a mounted electronics compartment lid;

FIG. 7 is a fragmentary, perspective, sectional view taken along the line VII-VII in FIG. 6 in the region of a support point, forming a radial and axial adhesive gap, of the electronics compartment lid in the carrier-side sealing or receiving groove; and

FIG. 8 is a further fragmentary, sectional view taken along the line VIII-VIII in FIG. 6 in the region of adhesive gaps formed between a lid wall of the electronics compartment lid and the sealing or receiving groove on the carrier side.

### DETAILED DESCRIPTION OF THE INVENTION

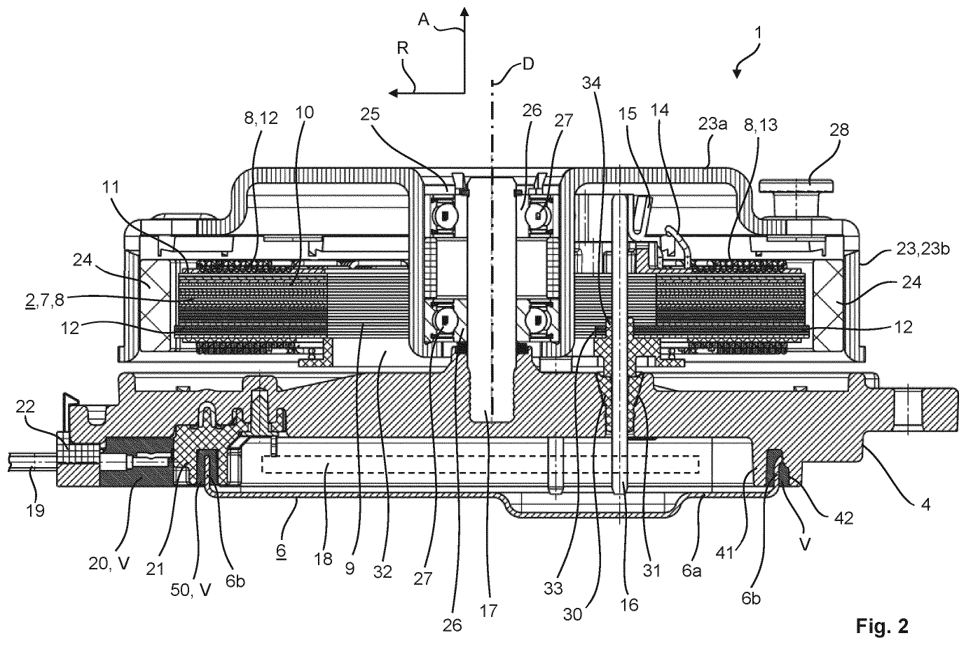

Reference is now made in detail to the figures of the drawings, in which corresponding parts and sizes are marked with the same reference signs in all figures. Specifications such as axial and radial refer to a motor axis (rotation axis) D indicated in FIG. 2 and refer to the axial and radial directions A and R, respectively, shown in FIG. 2.

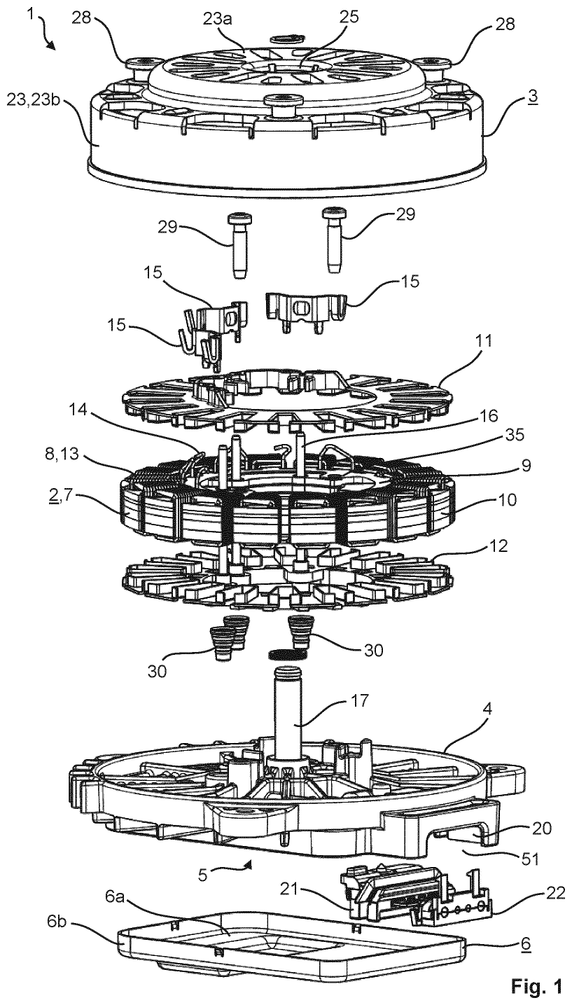

In particular, FIGS. 1 and 2 show an exploded view and a sectional view of an electric motor 1 configured with an external rotor, which is preferably intended and set up as a drive for a radiator fan of a motor vehicle. The electric motor 1 substantially has a stator 2 and a rotor 3 circulating around it as well as a (plate-like or plate-shaped) motor carrier 4, also referred to below as a support plate, with an electronics compartment 5, which can be closed with an electronics compartment lid 6. The motor carrier 4 is preferably a die-cast aluminum part. The electronics compartment lid 6, preferably made of aluminum or stainless steel, has a lid base 6a and a lid wall 6b molded thereon.

The stator 2 has a stator main body 7 and a stator or rotating field winding 8. The stator main body 7 is preferably formed from a number of laminations stacked to form a laminated core. The stator 2 or its stator main body 7 has an annular main body part 9 and radially outwardly directed stator teeth 10 molded onto the outer side.

Coil or winding insulations 11, 12 are provided on both sides of the stator main body 7 or the laminated core and are also referred to below as the upper coil insulation 11 facing away from the motor carrier 4 and the lower coil insulation 12 facing the motor carrier 4. The coil insulations 11, 12, which are preferably made of a plastic, for example manufactured as an injection-molded part, cover the stator main body 7 and in particular the stator teeth 9, in each case at or on one stator side. The stator main body 7 of the stator 2 covered by the coil insulations 11, 12 is provided with the stator winding 8, which is preferably formed of interconnected coils 13, which in turn are wound onto the individual stator teeth 10.

In FIG. 1, the two coil insulations 11, 12 are shown separately to make them recognizable, while FIG. 2 shows the actual assembly situation of the stator main body 7 provided with the coil insulations 11, 12. This is wound with the coils 13 of the stator winding 8 with the coil insulations 11, 12 interposed. Winding loops or winding ends 14 of the stator winding 8 are electrically conductively connected to busbar-like connection contacts 15, which connection contacts 15 are contacted, for example welded, with contact pins 16.

The motor carrier 4 has, on its support side assigned to the stator 2 and the rotor 3, a rigid rotation axis in the form of an axle bolt 17, which is cast into the motor carrier 4 or disposed in a bolt receptacle of the motor carrier 4 in a rotationally fixed manner, for example cast or compressed therein. The axle bolt 17 effectively forms the rotation axis or motor axis D of the electric motor 1 or rotor 3.

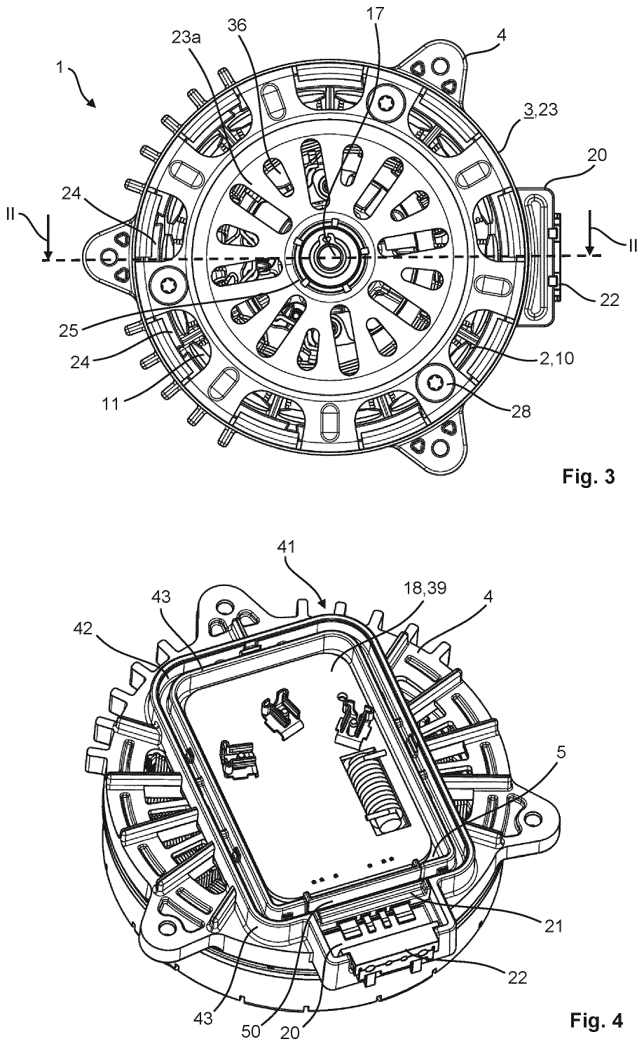

On the carrier side opposite the stator 2 and the rotor 3, the electronics compartment 5 for the motor electronics 18 (FIGS. 2 and 3) is provided in the motor carrier 4. The electronics compartment 5 opens at one end into a plug compartment 20, into which two plug parts 21, 22, which are provided for contacting with a connection cable 19 (FIG. 2), can be inserted in the exemplary embodiment; these are also referred to below as the inner plug part 21 and outer plug part 22. When the electric motor 1 is installed, the electronics compartment 5 is sealed, in particular in a moisture-proof manner, with the electronics compartment lid 6.

The rotor 3 has a pot-like rotor housing 23 with a housing base 23a and a housing wall (annular or housing wall) 23b oriented in the axial direction A. Permanent magnets 24 are disposed on the inside of this wall. The rotor housing 23 has a central, preferably hollow-cylindrical housing section deep-drawn in the housing base 23a as a bearing housing 25 for two roller or ball bearings 26, which are axially spaced relative to the rotation axis D in the exemplary embodiment. Their unspecified outer rings are held non-rotatably in the deep-drawn bearing housing 25 and their unspecified inner rings are firmly connected to the axle bolt 17, wherein bearing balls (bearing elements) 27 are disposed between the outer and inner rings (FIG. 2).

Mounting elements 28, for example screws, correspond to the rotor housing 23 for fastening a fan wheel, not shown, of the radiator fan to the rotor 3. The other fastening elements 29 shown, for example screws or bolts, are used to fasten the stator 1 to the motor carrier 4. Collar-like or plug-like sealing elements 30 for the contact pins 16 can also be seen in order to seal them off from the motor carrier 4. For this purpose, the motor carrier 4 has corresponding through-openings 31, in which the sealing elements 30, through which the contact pins 16 pass, fit in a sealing manner. The contact pins 16 protrude into the electronics compartment 5 in order to make contact with the motor or inverter electronics 18. In the exemplary embodiment, a three-phase stator winding 8 is provided, so that correspondingly three contact pins 16 connected via the connection contacts 15 as contact elements to the coils 13 of the stator or rotating field winding 8 are provided as phase connections for the stator or rotating field winding 8 and are routed to the motor electronics 18 and (electrically) contacted there.

As can be seen in FIG. 2, the annular main body part 9 of the stator main body 7 forms a receiving or mounting space 32, in which the axle bolt 17 oriented in axial direction A is located as the rotation axis D for the rotor 3. In addition, the contact pins 16 serving as phase connections are located in this receiving space 32. Furthermore, a radial lug 33 serving as a feedthrough for the respective contact pin 16 protrudes into the receiving space 32. This is formed from some of the laminations of the stator main body 7. An insulating dome or pin 34 protrudes, preferably form-lockingly, into the radial lug 33 or its through-opening, through which the respective contact pin 16 passes. The insulating dome or insulating pin 34 is preferably a component of the coil insulation 12 shown at the bottom in FIGS. 1 and 2, and is therefore preferably molded onto it.

With reference to FIG. 1, at least one further radial lug 35 is also formed by the stator main body 7 of the stator 2 or by its lamination stack and projects into the receiving space 32. The radial lug 35 has a through-opening for the respective fastening element or fastening bolt 29 and is used with this to hold the stator 2 on the motor carrier 4, in particular for screw fastening.

FIG. 3 shows the electric motor 1 in a top-plan view of the rotor 3 or its rotor housing 23. A number of ventilation slots 36 for dissipating heat generated during motor operation of the electric motor 1 can be seen in the housing base 24. Further housing openings 37 are provided on the circumference or in the transition region between the housing base 23a and the housing wall 23b of the rotor housing 23. It can be seen that the connector compartment 20 adjacent to the electronics compartment 5 protrudes above the rotor 3. The connector compartment 20 therefore protrudes radially above the rotor 3.

FIG. 4 shows the electric motor 1 from the carrier side opposite the stator 2 and the rotor 3 with a view into the electronics compartment 5. A printed circuit board 39 for electrical or electronic components of the motor electronics 18 and, for example, contact clamps 40 for the contact pins 16 passing through the printed circuit board 39 can be seen there.

The electronics compartment 5 is surrounded by an axially raised sealing wall 41. The sealing wall 41 on the carrier side has a receiving groove 42. In other words, the sealing wall 41 is configured as a double wall forming the receiving groove 42 with parallel sealing or groove walls 43 and a groove base 44. In the assembled state, the lid wall 6b of the electronics compartment lid 6, which is preferably closed peripherally, engages in the receiving groove 42 on the carrier side. In other words, the electronics compartment lid 6 is seated with its lid wall 6b in the carrier-side receiving groove 42.

The clear width or the groove width of the receiving groove 6 is at least slightly greater than the wall thickness of the lid wall 6b of the electronics compartment lid 6. As a result, a radial adhesive gap 45a, 45b is preferably formed on both sides of the lid wall 6b seated in the receiving groove 42 on the carrier side, which are also referred to below as the outer adhesive gap 45a and the inner adhesive gap 45b. In the assembled state, the lid wall 6b of the electronics compartment lid 6 is axially spaced from the groove base 44 of the receiving groove 42. As a result, an axial adhesive gap 46 is formed between the lid wall 6b of the electronics compartment lid 6 or its (circumferential) wall edge and the carrier-side receiving groove 42.

With the electronics compartment lid 6 seated in the receiving groove 42, the receiving groove 42 is filled with an initially liquid or viscous, hardenable potting or sealing compound V, for example. As shown in FIG. 2, the potting or sealing compound V that can be filled or is filled into the outer radial adhesive gap 45a also reaches the inner radial adhesive gap 45b via the axial adhesive gap 46, which inner radial adhesive gap is covered by the lid base 6a of the electronics compartment lid 6.

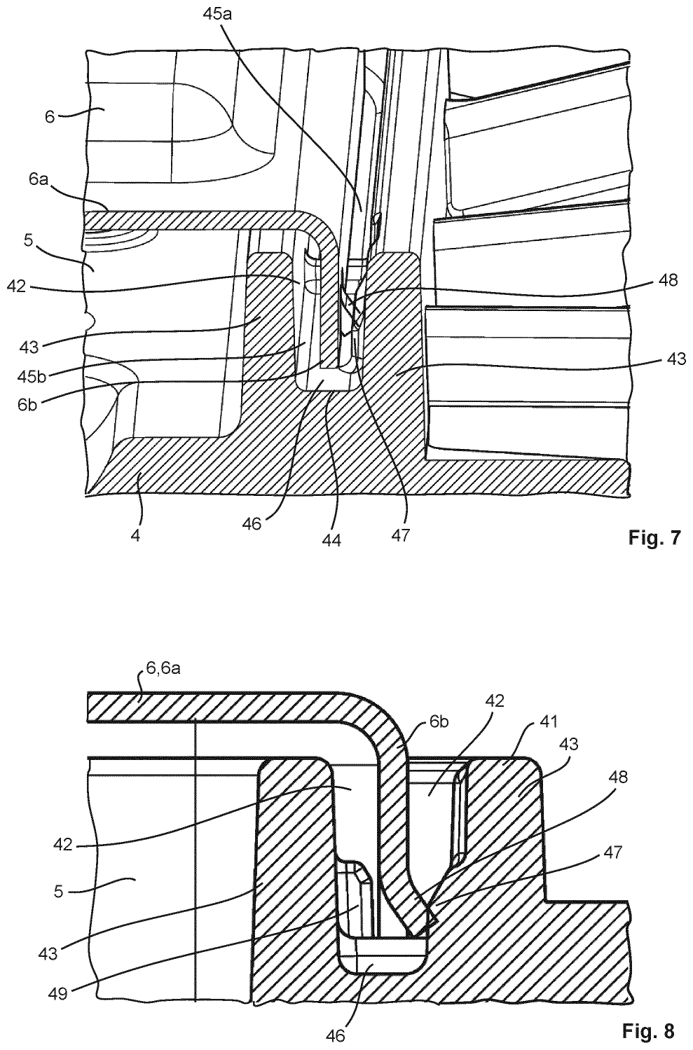

FIGS. 7 and 8 show sectional views of the assembled electronics compartment lid 6 before the potting compound is filled into the carrier-side receiving groove 42. In order to form the axial adhesive gap 46, local support domes 47 are provided in the carrier-side receiving groove 42 and project radially (in the radial direction R) into the receiving groove 42. The lid wall 6b of the electronics compartment lid 6 has radially outwardly oriented support lugs 48, which rest against or on the corresponding support dome 47 of the carrier-side receiving groove 42. The support lugs 48 are suitably configured as punched or punched and bent lugs of the electronics compartment lid 6, which is made of aluminum, for example.

Contact domes or contact cams 49 are provided on the groove wall 43 of the carrier-side receiving groove 42 opposite the support domes 47. These are preferably used for centering or positioning the electronics compartment lid 6 or its lid wall 6b within the carrier-side receiving groove 42.

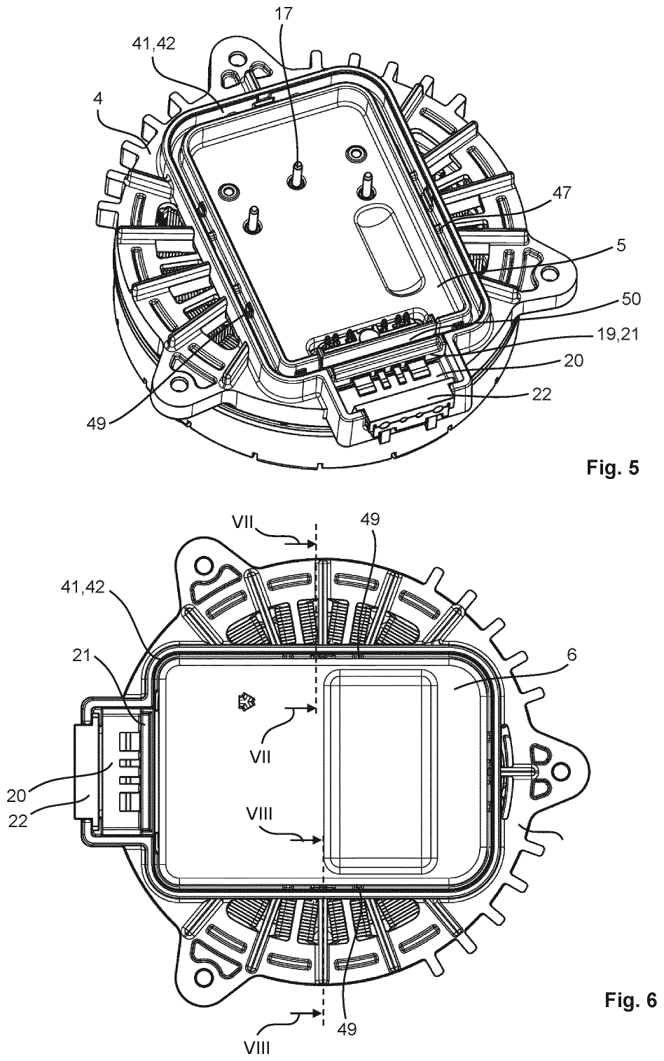

As can be seen comparatively clearly from FIG. 5, the radially inner plug part 21 on the end face 19′ of the electronics compartment 5 in the region of the carrier-side sealing groove or receiving groove 42 forms, on the one hand, a boundary wall between the electronics compartment 5 shown here without a circuit board and the plug compartment 20. On the other hand, a receiving groove 50 on the plug part side, which is adapted in terms of dimensions to the carrier-side receiving groove 42, is provided in or on this inner connector part 21. In the assembly state shown, the receiving groove 50 on the plug part side is aligned with the receiving groove 42 on the carrier side and, together with the latter, forms a circumferentially closed receiving groove 42, 50 for the lid wall 6b of the electronics compartment lid 6. Opposite the inner plug part 21, the plug compartment 20 is basically wall-free. In this front wall gap 51 (FIG. 1), the radially outer plug part 22 is inserted, forming a plug compartment 20 that is also closed peripherally.

FIG. 6 shows a plan view of the carrier side of the mounting carrier 4 facing away from the stator 2 and the rotor 3 with the electronics compartment lid 6 placed on the electronics compartment 5. The axial adhesive gap 46 formed or remaining between the electronics compartment lid 6 or its lid wall 6a and the carrier-side receiving groove 42 is filled with the potting compound V via the radially outer adhesive gap 45a, just like the radially inner adhesive gap 45b, as can be seen in FIG. 2. In the same way, the plug compartment 20 can also be filled with the potting compound V (FIG. 2).

Due to the formation of the carrier-side receiving groove 42 and the lid wall 6b of the electronics compartment lid 6, which is seated in the receiving groove with the formation of radial and axial adhesive gaps 45a, 45b, 46, a high degree of tightness of the electronics compartment 5 is achieved after filling and curing of the potting compound V. The seal formed by the potting compound V due to the radial and axial adhesive gaps 45a, 45b, 46 is—just like the cross—sectional contour of the interconnected or merging adhesive gaps 45a, 45b, 46—approximately U-shaped in cross-section. The hardened potting compound V acts in the manner of a labyrinth seal. This creates the largest possible infiltration path or the longest possible path for moisture. This in turn reliably prevents crevice corrosion in the sealed connection region between the electronics compartment lid 6 and the motor carrier 4.

In summary, the invention relates to an electric motor 1 including a motor carrier 4 with an electronics compartment 2 and with an axially raised sealing wall 41 or receiving groove 42, a stator 2 with a stator main body 7 having radially outwardly directed stator teeth 10 and a stator winding 8 disposed thereon, a rotor 3 circulating around the stator 2 (about a rotation axis D) with a pot-like rotor housing 23 with permanent magnets 24 disposed on the inner wall, and an electronics compartment lid 6 with a lid base 6a and with a lid wall 6b oriented axially with respect to the motor axis D, which forms at least one adhesive gap 45a, 45b, 46 with the sealing wall 41 or receiving groove 42 of the motor carrier 4 for receiving a potting compound V sealing the electronics compartment 5.

The claimed invention is not limited to the embodiments described above. Rather, other variants of the invention may also be derived therefrom by a person skilled in the art within the scope of the disclosed claims without departing from the subject matter of the claimed invention. In particular, all the individual features described in conjunction with the various exemplary embodiments can also be combined in other ways within the scope of the disclosed claims without departing from the subject matter of the claimed invention.

In addition, the solution described can be used not only in the specific application shown, but also in a similar configuration for other vehicle applications, such as door and tailgate systems, power windows, adjustable seat and interior systems and electric drives.

The following is a summary list of reference numerals and the corresponding structure used in the above description of the invention:
1 electric motor
2 stator
3 rotor
4 motor carrier/carrier plate
5 electronics compartment
6 electronics compartment lid
6a lid base
6b lid wall
7 stator main body
8 stator/rotating field winding
9 main body part
10 stator tooth
11 (upper) coil insulation
12 (lower) coil insulation
13 coil
14 winding loop/winding end
15 connection contact
16 contact pin
17 axle bolt
18 motor/converter electronics
19 connection cable
20 plug compartment
21 (inner) plug part
22 (outer) plug part
23 rotor housing
23a housing base
23b housing/annular wall
24 permanent magnet
25 housing portion/bearing housing
26 roller/ball bearings
27 bearing ball
28 mounting element
29 fastening element
30 sealing element
31 through-opening
32 receiving/mounting space
33 radial lug
34 insulating dome/pin
35 radial lug
36 ventilation slot
37 housing opening
39 circuit board
40 contact clamp
41 sealing wall
42 (carrier-side) receiving groove
43 sealing/groove wall
44 groove base
45a outer radial adhesive gap
45b inner radial adhesive gap
46 axial adhesive gap
47 support dome
48 support lug
49 contact dome/cam
50 (plug-part-side) receiving groove
51 wall gap
A axial direction
D motor/rotation axis
R radial direction
V potting/sealing compound

1. An electric motor or radiator fan motor of a motor vehicle, the electric motor comprising:
a motor carrier or plate-shaped motor carrier having an electronics compartment for receiving motor electronics, a carrier side associated with said electronics compartment, and a sealing wall or receiving groove being axially raised relative to a motor axis on said carrier side of said motor carrier;
a stator disposed on a support side of said motor carrier opposite said electronics compartment, said stator including a stator main body having radially outwardly directed stator teeth and a stator winding disposed on said stator main body;
a rotor circulating around said stator about a rotation axis, said rotor having a pot-shaped rotor housing with an inner wall and permanent magnets disposed on said inner wall; and
an electronics compartment lid closing said electronics compartment, said electronics compartment lid having a lid base and a lid wall integrally molded on said lid base and oriented axially relative to said motor axis, said lid wall forming at least one adhesive gap with said sealing wall or receiving groove of said motor carrier for receiving a potting compound sealing said electronics compartment.

2. The electric motor according to claim 1, wherein said sealing wall on said carrier side at least one of:
has an inner side with a step, and said lid wall of said electronics compartment lid rests against said step, forming said adhesive gap for the potting compound, or
is configured as a double wall, forming said receiving groove, and said lid wall of said electronics compartment lid dips or engages into said receiving groove.

3. The electric motor according to claim 1, which further comprises radial adhesive gaps for the potting compound each being formed on a respective side of said lid wall of said electronics compartment lid, said lid wall dipping into said receiving groove of said carrier-side sealing wall.

4. The electric motor according to claim 1, wherein said receiving groove has a groove base, an axial adhesive gap for the potting compound is formed between said groove base and said lid wall of said electronics compartment lid, and said lid wall dips into said groove base.

5. The electric motor according to claim 4, wherein said groove base is formed in or by said carrier-side sealing wall.

6. The electric motor according to claim 1, which further comprises at least one support dome projecting into said receiving groove, said electronics compartment lid being supported on said at least one support dome, forming said at least one adhesive gap as an axial adhesive gap for the potting compound.

7. The electric motor according to claim 5, wherein said at least one support dome is formed on said groove wall of said carrier-side receiving groove facing away from said electronics compartment.

8. The electric motor according to claim 1, wherein said carrier-side receiving groove has a groove wall, and said lid wall of said electronics compartment lid dips into said carrier-side receiving groove and has at least one flared support lug bearing against said groove wall of said receiving groove, forming said at least one adhesive gap as an axial adhesive gap for the potting compound.

9. The electric motor according to claim 8, wherein said at least one flared support lug bears against one of said at least one support dome.

10. The electric motor according to claim 1, which further comprises at least one contact dome projecting into said receiving groove, said lid wall of said electronics compartment lid being supported on said at least one contact dome, forming said at least one adhesive gap as a radial adhesive gap for the potting compound.

11. The electric motor according to claim 10, wherein said carrier-side receiving groove has a groove wall, and said at least one contact dome is formed on said groove wall of said carrier-side receiving groove facing said electronics compartment.

12. The electric motor according to claim 1, which further comprises a plug part, said carrier-side sealing wall or receiving groove enclosing a plug compartment into which the potting compound can be poured and forming a wall-free end face configured for receiving said plug part therein.
